(19) United States
(12) Patent Application Publication
(10) Pub. No.: US 2010/0215468 A1
(43) Pub. Date: Aug. 26, 2010

(54) LOADING LIFT

(76) Inventor: Dieter Kollewe, Frankenberg (DE)

Correspondence Address: MICHAEL J. STRIKER, 103 EAST NECK ROAD, HUNTINGTON, NY, 11743, US

(21) Appl. No.: 12/709,585

(22) Filed: Feb. 22, 2010

(30) Foreign Application Priority Data
Feb. 23, 2009 (DE) 20 2009 002 451.2

(51) Int. Cl. B60P 1/00; B60P 1/02; B60P 1/44; B66F 7/00; B66F 9/02

(52) U.S. Cl. 414/544; 414/787

(57) ABSTRACT

A loading lift for a vehicle, in particular for a motor vehicle and/or to overcome a difference of level in buildings, at public transportation ramps and the like comprising a holding stand (1,) to be attached to the motor vehicle and/or a wall or a ground area of the building or at the public transportation, a carriage (2) which can be moved backwards and forwards in a first direction on the holding stand (1) and a loading device (3) which can be mounted on the carriage (2) and can be moved backwards and forwards in a second direction substantially vertical to the first direction between a loading position and a transporting position is described. Therein the holding stand (1), the carriage (2) and the loading device (3) each consist of a module, it being possible for these modules to be selectively handled individually or to be inserted one inside another and connected together to produce a ready-made constructional unit.

### FIELD OF THE INVENTION

The invention relates to a loading lift for a vehicle, in particular for a motor vehicle and/or to overcome a difference of level in buildings, at public transportation ramps and the like comprising a holding stand to be attached to the vehicle and/or a wall or a ground area of the building or at the public transportation, a carriage which can be moved backwards and forwards in a first direction on the holding stand and a loading device which can be mounted on the carriage and can be moved backwards and forwards in a second direction substantially vertical to the first direction between a loading position and a transporting position. The invention also relates to vehicle.

### BACKGROUND OF THE INVENTION

Loading lifts of this type are used to facilitate the loading of goods in particular into the loading space of a passenger car, an estate car or a small lorry. For this purpose, a loading element which is mounted in the vehicle and is usually configured as a platform is moved backwards or to the side out of the loading space, set onto the ground, loaded and then raised again initially to the height of the loading area of the loading area. Thereafter, the goods are then either transferred manually from the loading element to the loading area or conveyed together with the loading element into the boot or loading space of the motor vehicle. Included in particular as goods to be loaded are heavy loads, for example all types of wheelchairs, rolling trucks, pallets or the like, but also for example specific goods such as pumps or other attachments of fire engines or emergency ambulances.

Many variants of the loading lifts of the type described at the outset are known. A known loading lift has, for example a holding stand which is to be attached in the vehicle and is in the form of a frame provided with running or guide rails, a carriage guided displaceably on this frame and a loading device which is attached to the carriage and comprises a lifting device and a loading platform attached to said lifting device (DE 20 2004 005 632 U1, DE 20 2007 010 020 U1, EP 0 329 697 B1). The lifting device comprises a double rocker, a parallelogram guidance or a pivoting mechanism, as a result of which the loading lift is overall very expensive in respect of construction and the costs associated therewith. Other known loading lifts are provided with similar parallelogram guidances (for example, DE 203 09 868 U1). Compared to this, lifting systems which can move a loading platform upwards and downwards by means of linear guides are of a simpler construction (for example DE 93 20 036 U1, DE 299 13 723 U1, EP 1 145 901 A1). Regardless of the fact that these loading lifts are mostly also of a complex construction, they have other shortcomings. Furthermore, common to all the mentioned loading lifts is the fact that they can only be installed into or removed from a motor vehicle with difficulty or even serve the purpose of remaining permanently in the vehicle. The latter case is undesirable because loading lifts of the described type are quite heavy (for example they weigh approximately upwards of 100 kg), which means that the empty weight of the vehicle would be greatly increased or the possible payload would be reduced accordingly. In contrast thereto, for reasons of first installation, dispatch, maintenance and repair, it is considered to be more favourable to provide a loading lift which can be installed and removed easily and can be dismantled into individual components.

Loading lifts as defined above also are used in bridging differences of level along transports of goods in buildings or at loading ramps. Additionally loading lifts are used in public transportation such as railroad as an aid enabling elderly or disabled people to enter or exit railroad cars. Loading lifts also are used in buildings for disabled people or wheelchair users to overcome steps or stairs. Thereby such loading lifts are preferred to lifts integrated in the building in case of the stairs extending only over a few steps. However, loading lifts known are complicated with respect to handling. Also an installation and dismantling thereof is laborious.

### SUMMARY OF THE INVENTION

Starting from this premise, the invention is based on the technical object of configuring the loading lift of the type described at the outset such that it is of a simple configuration, can be installed, removed and operated easily even by laymen and is service and maintenance-friendly.

This and others objects are solved in accordance with this invention by means of a loading lift of the kind mentioned above and being characterised in that the holding stand, the carriage and the loading device each consist of a module, it being possible for these modules to be selectively handled individually or to be inserted one inside another and connected together to produce a ready-made constructional unit.

The loading lift according to the invention is constructed in a modular manner from a holding stand, a carriage which is movable thereon and a loading device which can be mounted on the carriage. The modules, which can be handled individually, may be interconnected by mutually vertical guides. The inventive loading lift is adapted to be used in vehicles such as ships, aeroplanes or motor vehicles. The inventive loading lift also can be provided in buildings in order to overcome a difference of level as given at stairs and the like. The loading lift also can be used at loading ramps for loading of motor vehicles or at a quay for loading or reloading of ships. The invention also provides a loading lift to be used at transportation to allow elderly or disabled people entering or leaving railroad cars or the like.

The invention provides the particular advantage that the loading lift has three main components which are configured as complete modules and can be easily assembled and therefore also easily dismantled again. Consequently, it is unnecessary to perform either the installation or the maintenance and/or repairs in special workshops. Furthermore, storage is substantially simplified. Since the weight of an individual module only needs to be approximately 30 to 40 kg, the loading lift or the modules thereof can be easily handled by a single person without using cranes, fork lift trucks or the like. This makes it possible to use the motor vehicle without complex mounting and dismounting operations selectively with or without a loading lift. If quick-acting closures known per se are provided for attaching the holding stand module in the vehicle, preferably quick-acting closures of the type which can be attached to securing points present anyway in modern motor vehicles, then in the context of road traffic regulations, the loading lift is not considered as a fixed installation, but as loaded goods, so that an MOT certificate and entries in the vehicle documents are not required. This applies whether or not the loading lift according to the invention is installed in a passenger car or in a lorry.

Further advantageous features of the invention are set out in the subclaims.

### BRIEF DESCRIPTION OF THE DRAWINGS

In the following, the invention will be described in detail on the basis of embodiments in connection with the accompanying drawings, in which:

FIGS. 1a and b schematically show a perspective and exploded view of a first embodiment of a loading lift according to the invention;

FIG. 2 is an enlarged front view of an angular element, provided with rollers, of a holding stand of the loading lift according to FIG. 1a;

FIG. 3 is a plan view of the angular element according to FIG. 2;

FIGS. 4 and 5 are views corresponding to those of FIGS. 2 and 3 of a further angular element of the holding stand of the loading lift according to FIG. 1a;

FIGS. 6a and b are perspective views of the loading lift according to FIGS. 1a and b in a state assembled into a ready-for-use constructional unit;

FIG. 7 is a side view of the angular element according to FIG. 2 from the left-hand side and of a roller rail, associated therewith, of a carriage of the loading lift according to FIGS. 1a,b and 6a,b;

FIG. 8 is a side view, corresponding to FIG. 7, of the angular element according to FIG. 4 and of a roller rail, associated therewith, of the carriage of the loading lift according to FIGS. 1a,b and 6a,b;

FIG. 9 to 11 are respectively a side view, a plan view and an enlarged rear view of a small lorry with an installed loading lift withdrawn into a loading space, according to a second embodiment of the invention;

FIG. 12 schematically shows an enlarged arrangement of roller rails which is provided for the backwards and forwards movement of a carriage module of the loading lift according to FIG. 9 to 11;

FIG. 13 to 15 are views, corresponding to those of FIG. 9 to 11, of the small lorry in a loading position of the loading lift;

FIGS. 16 and 17 are views similar to those of FIGS. 2 and 4 of a roller rail arrangement of the loading lift according to FIG. 9 to 15; and

FIG. 18 to 23 show a quick-acting closure suitable for attaching the loading lift in a motor vehicle, FIG. 18 to 20 respectively showing a front view, a plan view and a side view of a mounting rail and FIG. 21 to 23 respectively showing a side view, a plan view and a side view of a sealing element associated with the mounting rail.

### DETAILED DESCRIPTION OF PREFERRED EMBODIMENTS OF THE INVENTION

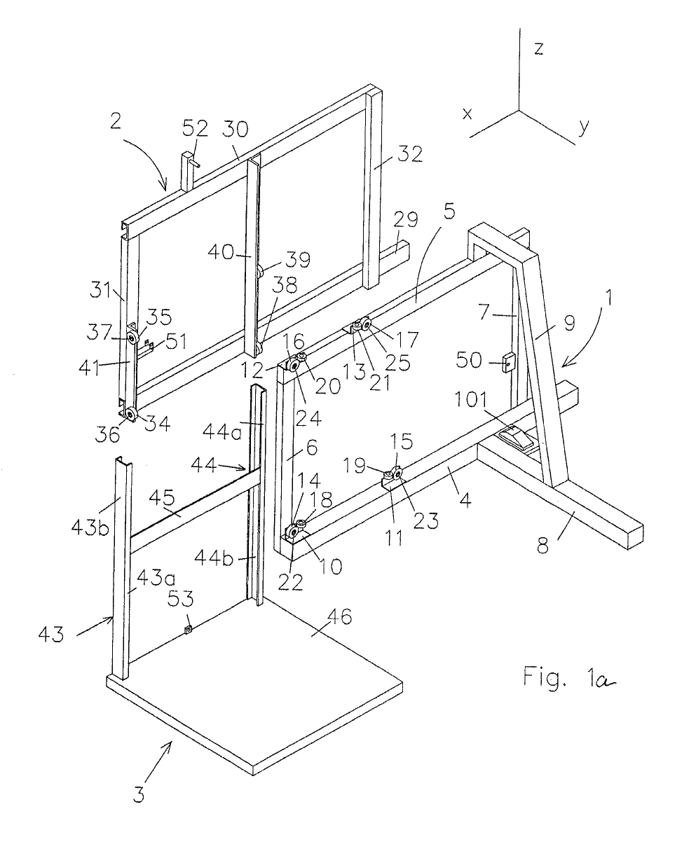

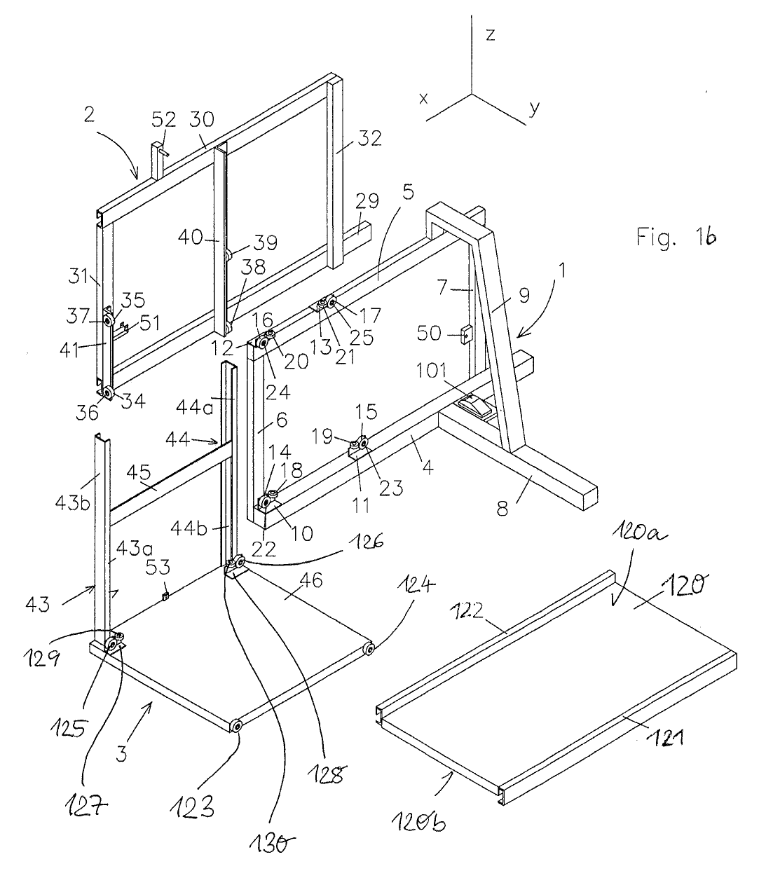

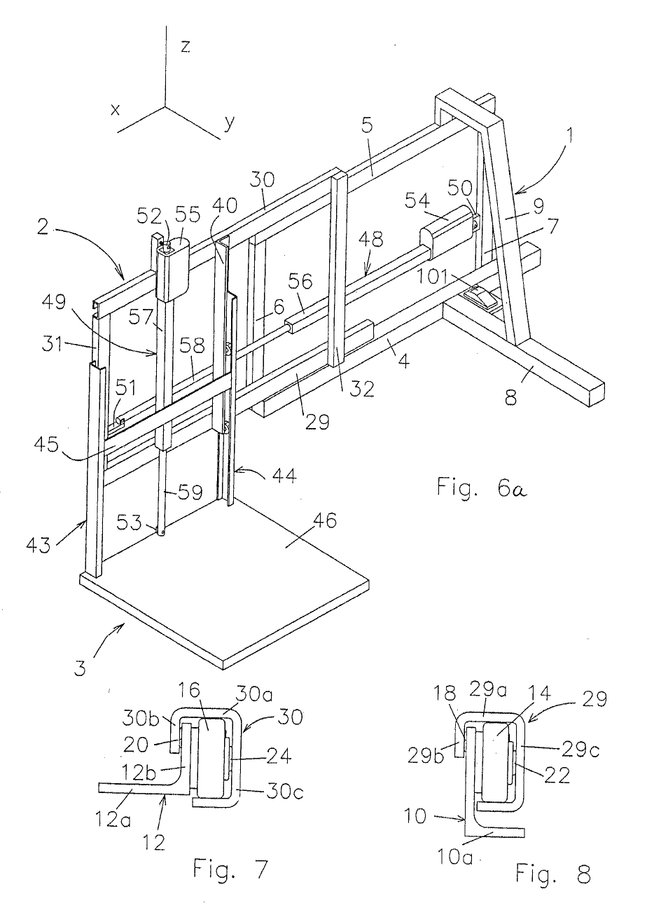

According to FIG. 1a, a loading lift according to the invention comprises a holding stand 1, a carriage 2 and a loading device 3. Each of these three parts consists of a preferably fully pre-assembled module which can be handled as an entity. Therefore, each module can be stored, maintained or repaired individually. Alternatively, it is possible to assemble the three modules in the manner shown in FIG. 6a into a ready-made constructional unit, as will be described in more detail further below.

The holding stand 1 comprises two preferably straight longitudinal beams 4 and 5 and two corresponding crossbeams 6 and 7 which are preferably arranged vertically to the longitudinal beams 4 and 5 and connect them. The beams 4 to 7 are made, for example of bending-resistant rectangular tubes and are connected together to form a rectangular frame, longitudinal axes of the longitudinal beams 4 and 5 being arranged parallel to one another and parallel to the x-axis of an imaginary coordinate system and longitudinal axes of the crossbeams 6 and 7 being arranged parallel to one another and parallel to the z-axis of the imaginary coordinate system. At one lateral end, the frame is attached to a substructure which has a foot 8 connected to the beam 4 with a longitudinal axis preferably arranged parallel to the y-axis of the coordinate system and a support 9 rising from said foot 8 and connected to the longitudinal beam 5. Due to this arrangement, the frame forms with the four beams 4 to 7 a cantilever arm projecting laterally from the substructure, the foot 8 and the support 9 preferably being in a plane which is arranged parallel to the yz plane and thus arranged vertically to the plane of the frame and being arranged here parallel to the xz plane of the imaginary coordinate system.

Attached to the longitudinal beams 4 and 5 are respectively two angle pieces 10 to 13, the angle pieces 10, 12 being arranged on ends remote from the support 9 and the angle pieces 11, 13 being arranged in central regions of the longitudinal beams 4, 5. The angle pieces 10 to 13 support a respective first, rotatably mounted roller 14 to 17 having here a comparatively large diameter as well as a second, rotatably mounted roller 18 to 21 having here a comparatively small diameter. In the embodiment, the axes of rotation of the first rollers 14 to 17 are each parallel to the y-axis and the axes of rotation of the second rollers 18 to 21 are each parallel to the z-axis of the imaginary coordinate system. Furthermore, the first rollers 14 to 17 are configured as combination rollers and are provided with a central recess in which a respective third roller 22 to 25 having a comparatively small diameter is rotatably mounted, the axes of rotation of which are arranged parallel to the z-axis in the installed state.

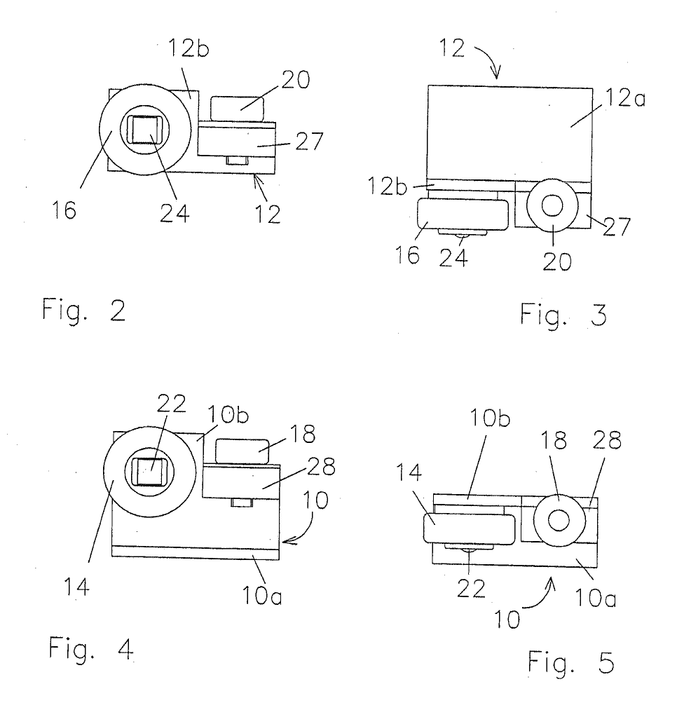

As shown more precisely by FIGS. 2 and 3, the angle piece 12 has two sides 12a, 12b which are vertical to one another, the side 12a being attached to the upper side of the longitudinal beam 5, while the side 12b rising vertically therefrom supports the first and second rollers 16, 24. Provided directly adjacently in the x-direction is a square piece 27 which is directly attached to the angle piece 12 on the upper side of the longitudinal beam 5 or in a recess in the side 12b and it supports the second roller 20. As shown in FIGS. 4 and 5, the angle piece 10 correspondingly has two sides 10a, 10b, the side 10a being attached to the upper side of the longitudinal beam 4, while the side 10b rising vertically therefrom supports the first and third rollers 14, 22. Provided directly adjacently in the x-direction is a square piece 28 which is directly attached to the angle piece 10 on the upper side of the longitudinal beam 4 or in a recess in the side 10b and it supports the roller 18. The angle pieces 11 and 13 are configured accordingly and are provided with rollers 15, 19, 23 and respectively 17, 21, 25, as can be clearly seen in FIG. 1. Furthermore, the arrangement is such that all the rollers project at the same side of the frame formed by the longitudinal beams and crossbeams 4 to 7, i.e. at the front side of the frame in the embodiment.

The frame formed by the longitudinal beams and crossbeams 4 to 7 and the parts attached thereto form a preferably prefabricated holding stand module.

The carriage 2 comprises two straight longitudinal beams configured as roller rails 29, 30 and likewise two straight crossbeams 31 and 32 which are preferably arranged vertically thereto and consist, for example of rectangular tubes, are connected to the guide rails 29, 30 and form therewith a rectangular frame. The roller rails 29, 30 have a U- or C-shaped cross section and act as tracks for the rollers 14 to 25. For this reason, the roller rails 29, 30 have a spacing from one another which corresponds to the spacing, measured in the z-direction, of the rollers 14, 15 from the rollers 16, 17. Furthermore, the arrangement is such that the roller rails 29, 30 can be pushed onto or attached to the rollers mounted on the holding stand 1 in the x-direction and from outside or, in FIG. 1a, from the left-hand side, as can be seen in FIGS. 6a and b. For this purpose, the cross sections of the roller rails 29, 30 according to FIGS. 7 and 8 are selected such that sides 29a, 30a rest from above against the first rollers 14 and respectively 16, sides 29b, 30b rest against the rollers 18, 20 and sides 29c, 30c come to rest against the third rollers 22, 24. Assuming that the longitudinal beams 4, 5 are arranged horizontally, i.e. parallel to the x-direction in the position of use, the first running wheels 14 to 17 thus support the carriage 2 in a vertical direction, while the rollers 18, 22 and respectively 19, 23 produce a lateral guidance which acts in the direction of the y-axis of the imaginary coordinate system, of the roller rail 29 and the rollers 20, 24 and respectively 13, 25 correspondingly produce a lateral (horizontal) guidance of the roller rail 30. Particularly advantageously, the various rollers can also be arranged such that they are adjustable to allow a substantially clearance-free movement of the carriage 2 on the holding stand 1.

Two fourth rollers 34 and 35 which are spaced apart in their longitudinal direction are rotatably attached to the crossbeam 31. The axes of rotation of these rollers 34, 35 are arranged parallel to the longitudinal beams 29, 30 of the carriage 2. In addition, the fourth rollers 34, 35 are configured like the first rollers 14 to 17 as combination rollers and are provided with a central recess in which a respective fifth roller 36 and 37 is rotatably mounted, the axes of rotation of which, in the installed state, are arranged vertically to the axes of rotation of the fourth running wheels 34, 35 and also vertically to the longitudinal axes of the crossbeams 30 and 31.

Corresponding fourth rollers 38 and 39 are mounted rotatably on a crossbeam 40 which is arranged in a central region of the carriage 2 and parallel to the crossbeams 31, 32 and is connected to the longitudinal beams 29, 30. These rollers 38, 39 are also combination rollers which carry therein rotatably mounted fifth rollers which correspond to the rollers 36, 37 but cannot be seen in FIG. 1a. Furthermore, the fourth and fifth rollers 34 to 39 according to FIG. 1a are preferably attached by angle pieces (for example 41) corresponding to the angle pieces 10 to 13 to the crossbeams 31 and 40 such that they slightly project forwards out of the frame formed by the beams 29 to 32 and 40, as can be clearly seen in FIG. 1a.

The frame formed by the longitudinal beams and crossbeams 29 to 32 and 40 and the parts mounted thereon form a preferably prefabricated carriage module.

In the embodiment, the loading device 3 comprises two longitudinal beams which are configured as roller rails 43, 44 and are connected in a central part by a crossbeam 45. At their lower ends, the roller rails 43, 44 are rigidly connected to a loading element 46 which is configured, for example as a plane-parallel plate, as a fork configured in the manner of a fork lifter or configured in another manner.

The roller rails 43, 44 are arranged in spacings which correspond to the spacings of the rollers 34, 38 and respectively 35, 39, preferably have a U- or C-shaped cross section and act as tracks for the fourth and fifth rollers 34 to 39. Furthermore, the rollers 34 to 39 are preferably mounted analogously to the rollers 14 to 25 such that the roller rails 43, 44 can be pushed onto or attached to the rollers 34 to 39 mounted on the carriage 2 in a similar manner and, for example from below in FIG. 1, as described above with reference to FIGS. 7 and 8 for pushing the roller rails 29 and 30 onto the rollers 14 to 25 of the holding stand 1. In this respect, for example the fourth rollers 34, 35 and 38, 39 run on lateral sides 43a, 44a and the fifth rollers 36, 37 roll on middle sides 43b, 44b of the roller rails 43, 44 of the loading device 3.

This aside, the frame formed from the roller rails 43, 44 and the crossbeam 45, and the loading platform 46 form a preferably prefabricated loading device module.

In a further embodiment of the loading lift, shown in FIG. 1b, a positioning platform 120 is provided for sliding onto the loading platform 46. The preferably rectangular positioning platform 120 comprises a guide rail 121, 122 along each of the longitudinal edges thereof. A guide rail 122, which faces the roller-rail-type longitudinal carriers 43, 44 of the loading device 3 once slid onto the loading platform 46, thus projects over an upper side 120a, for receiving loading, of the positioning platform 120. The guide rail 121 provided opposite the guide rail 122 is attached so as to project downwards past a lower side 120b of the positioning platform 120. This type of attachment of the guide rails 122, 121 which correspond to the roller rails 29, 30 enables guidance by means of rotatably mounted rollers 123 to 126, attached to the loading platform 46 and having axes of rotation parallel to the receiving surface of said loading platform 46.

In this case, the rollers 123, 124 are provided on an end-face edge portion, remote from the roller rails 43, 44, of the loading platform 46. The rollers 125, 126 are attached to angle pieces 127, 128, which are fixed by the sides thereof to the roller rails 43, 44 and the loading platform. Angle pieces 127, 128 correspond to angle pieces 10 to 13 in terms of construction and materials used therein. When the positioning platform 120 is slid onto the loading platform 46, the rollers 125, 126 engage in the guide rail 122 having a substantially C-shaped profile. The same applies to the rollers 123, 124 in relation to the guide rail 121. With the support of the rollers 123, 124, the rollers 125, 126 hold the positioning platform 120, while receiving the forces exerted thereon by loaded items, on the loading platform 46. Rotatably mounted rollers 129, 130, attached to the angle pieces 127, 128 respectively and having axes of rotation parallel to the roller rails 43, 44, guide the C-shaped guide rail 122 when the positioning platform 120 is positioned on the loading platform 46, to avoid tilting of the positioning platform 120.

The rollers 123 to 126 correspond to the rollers 36 to 39 and the rollers 129, 130 correspond to the rollers 18 to 21. The positioning platform 120 preferably comprises a welded frame and can in particular be set down while withdrawn at least in part from the loading platform 46, to form stable loading bridges on ramps and the like. The positioning platform 120 when placed on the loading platform 46 is secured by means of stop motion devices known in the art against disengaging from the loading platform 46. The positioning platform 120 can be drawn out with respect to the loading platform 46 along x-direction. FIG. 6b shows an extended position of the positioning platform 120. The positioning platform 120 and the loading platform 46 are able to receive heavy goods, such as heating boilers. As is shown in FIG. 6b, according to the invention the positioning platform 120 is dimensioned in such a way that it can receive conventional pallets, in particular Euro pallets, box pallets, freight containers or conventional receptacles when transporting goods.

The assembly of the three modules is extremely simple. For example, it is possible to join the holding stand 1 and the carriage 2 together such that they are inserted one inside the other and for this, the rollers 14 to 25 are introduced into the associated roller rails 29, 30. The carriage 2 can then be moved backwards and forwards on the holding stand 1 manually and parallel to the longitudinal beams 4, 5 of the holding stand 1, the first to third rollers running in the roller rails 29 and 30. In a corresponding manner, the carriage 2 and the loading device 3 can be inserted one inside the other and for this, the rollers 34 to 39 are introduced into the associated roller rails 43, 44. Roller rails 43, 44 in this way also function as guide rails. The loading device 3 can then be moved backwards and forwards on the carriage 2 manually and parallel to the crossbeams 31 and 40 of the carriage 2, the fourth and fifth rollers 34 to 39 running in the roller rails 43, 44. In this manner, it is possible to assemble all three modules together, thereby producing the ready-for-use constructional unit according to FIG. 6a. This unit can be dismantled into three modules simply by moving the modules in opposite directions, thereby removing the roller rails from the associated rollers.

If it is desired to restrict the movement stroke of the modules when they are assembled, for example to prevent an undesirable dismounting, this can be achieved by providing the ends of the respective roller rails with suitable, detachable stops. These stops serve to restrict the movement stroke and also to produce a firmly cohesive constructional unit.

According to a particularly preferred embodiment, considered to be the best hitherto, the carriage 2 and/or the loading device 3 can also be moved backwards and forwards by means of any motor or the like. For this purpose, according to FIG. 6a, a first drive 48 is provided to move the carriage 2 relative to the holding stand 1 and/or a second drive 49 is provided to move the loading device 3 relative to the carriage 2. Both drives 48, 49 are preferably configured as linear drives which are each arranged between two hold points 50, 51 and respectively 52, 53 and are rigidly connected thereto. According to FIGS. 1a and b and FIGS. 6a and b, for example one of the hold points 50 for the first drive 48 is attached to the crossbeam 7 of the holding stand 1, while the other hold point 51 is attached to the crossbeam 31 of the carriage 2. On the other hand, one of the hold points 52 for the second drive 49 is fitted to the longitudinal beam 30 of the carriage 2, while the other hold point 53 is fitted to the trailing end of the loading element 46. For connection purposes, readily detachable connection elements are preferably used so that for mounting/dismounting the modules, the drives 48, 49 can easily be connected to the associated hold points 50 to 53 or can be easily detached therefrom.

The drives 48, 49 preferably consist of linear drives. For this purpose, they have, for example a respective electric reversing motor 54, 55 which is connected to a hold point (for example 50, 52) and to which a tube 56, 57 is attached in which are arranged a threaded spindle which can be set into rotation by the reversing motor 54, 55 and a nut which is screwed on said threaded spindle, cannot rotate in the tube 56, 57 but is mounted in an axially displaceable manner. The nut is respectively connected to a rod 58, 59 which protrudes out of the tube 56, 57 and the free end of which is connected to the respectively other hold point 51, 53. In this manner, the carriage 2 and/or the loading device 3 can be moved backwards and forwards by the motors by switching the respective reversing motor 54, 55 in one or other direction of rotation. Alternatively, it is of course also possible for other drives to be provided, for example hydraulically or pneumatically operated drives in the form of cylinder/piston arrangements or the like. In addition, to move the carriage 2 and/or the loading device 3, a respective manually operable crank handle (not shown) which can optionally be integrated into the corresponding drive can be present which allows emergency operation. Finally, it is advantageous to provide limit switches which disconnect the drives when preselected positions of the carriage 2 and/or of the loading device 3 have been reached and thus serve at the same time to restrict the stroke, and/or to provide safety clutches which respond to an overload. This aside, the attachments provided at the hold points 50 to 53 also serve to provide a ready-for-use, firmly cohesive constructional unit.

To put the loading lift into operation, the substructure 8, 9 is positioned, for example close to a rear wall of a lorry platform, of a passenger car boot or the like and attached to the floor thereof, for example by the foot 8 such that the longitudinal beams 4, 5 are arranged parallel to the longitudinal axis of the vehicle in order to use the loading lift from the rear end of the respective vehicle. Other attachments are also possible. They often arise as a function of attachment points which are provided anyway on motor vehicles. The longitudinal beams 4, 5 are then arranged parallel to the imaginary x-axis, i.e. horizontally, while the crossbeams 6, 7 are arranged parallel to the imaginary z-axis, i.e. vertically.

In the described manner, the carriage 2 is then positioned on the holding stand 1 and the loading device 3 is positioned on the carriage 2 and they are moved into their furthest retracted positions in the x-direction respectively z-direction of the imaginary coordinate system. In this position, they are for example fully positioned inside a boot or other loading space or inside the peripheral contour of the motor vehicle concerned in a transporting position, the loading element 46 preferably resting on the respective loading area.

If a loading procedure is to be carried out first of all the loading device 3 is raised in the z-direction, for example by means of the drive 49 until it is positioned slightly above the loading area and, if appropriate, also above a threshold delimiting said loading area. This position is determined, for example, by a limit switch which stops the drive 49. The carriage 2 is then moved into the furthest extended position in the x-direction, for example by the drive 48, which position is determined by a limit switch which stops the drive 48 and is selected such that the loading device 3 is now located completely outside the peripheral contour of the motor vehicle concerned. The loading device 3 is then lowered in the z-direction, for example by means of the drive 49 until the loading element 46 rests on the road on which the motor vehicle is also parked, which position is indicated, for example by a separate sensor which stops the drive 49.

The loading element 46 can be loaded in the loading position, thus reached, of the loading lift. Thereafter, the loading element 46 is moved upwards again into an upper end position which is determined by a further limit switch and is slightly higher than the loading area or the threshold delimiting it. The carriage 2 is then withdrawn into the loading space or the like and held in a position determined by a limit switch. Thereafter, the loading device 3 is slightly lowered until the loading element 46 rests on the loading area. The loading lift is once again in its transporting position.

The loading material can selectively remain on the loading element 46 or can be rolled or pushed from there further inside the vehicle or the like. In particular, wheelchairs or the like can be rolled to other areas of the loading area to make room for at least a further wheel-chair. Self-propelling wheelchair users can do this themselves.

Alternatively, it is possible after loading to raise the loading element 46 only up to the level of the loading area and to lift or roll the loading material from there into the vehicle, for which purpose a flap (not shown) which is mounted pivotally on the loading element 46 can be opened out and used as a bridge to the loading area. It is then possible to lower the loading device 3 faster back into the loading position.

If the loading lift which has been described is not needed, it can be easily dismantled. For this purpose, the carriage 2 is fully extended and the loading device 3 is lowered onto the ground. The drive 48 at the hold point 51 is then released and the rod 58 is withdrawn into the tube 56. During this procedure, the carriage 2 remains in an extended position and then, together with the loading device 3, is drawn away outwards from the vehicle and removed from the holding stand 1. The carriage 2 can then be separated from the loading device 3, if required, for which for example the connection at the hold point 53 is released. Finally, the holding stand 1 is released from the vehicle, removed therefrom and set down in a suitable place so that the vehicle can also be used without any parts of the loading lift.

Alternatively, all the described movements can also be performed in order to unload material located in the vehicle and/or they can be performed manually, in particular for example using crank handles (not shown) or the like and in a different manner to the one described.

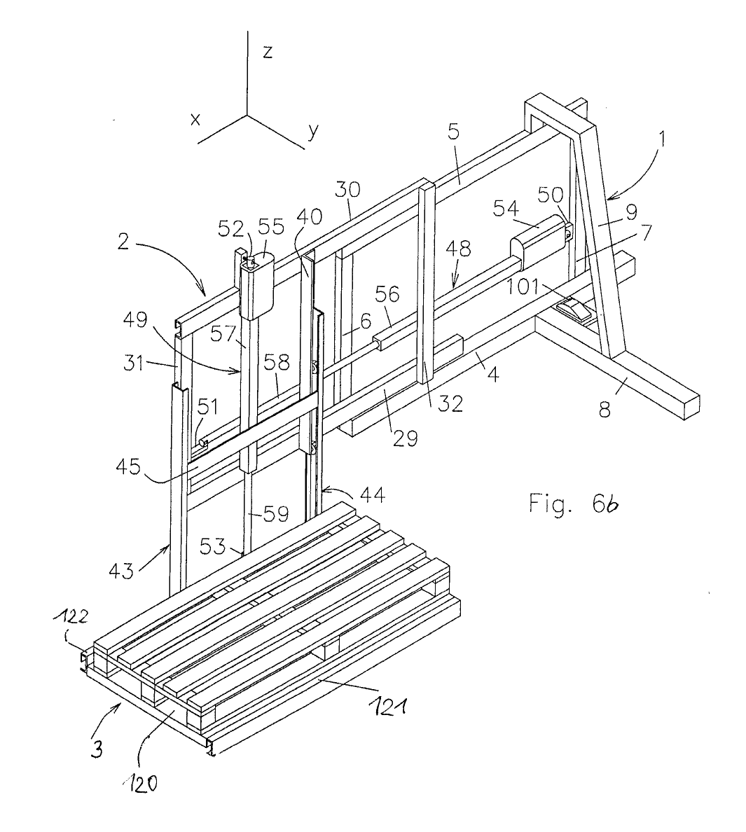

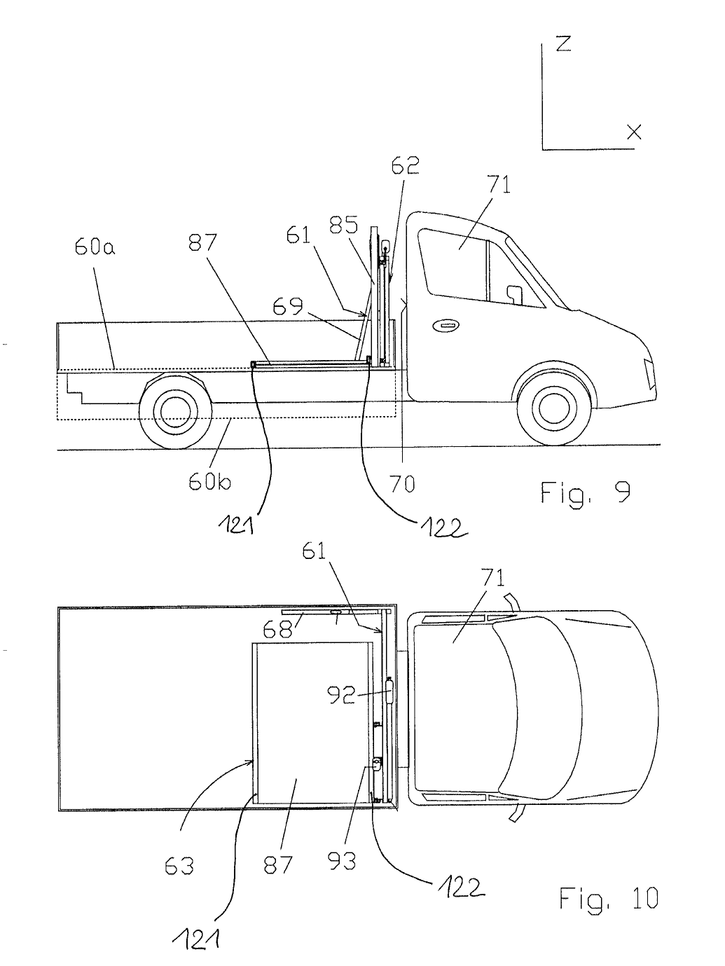

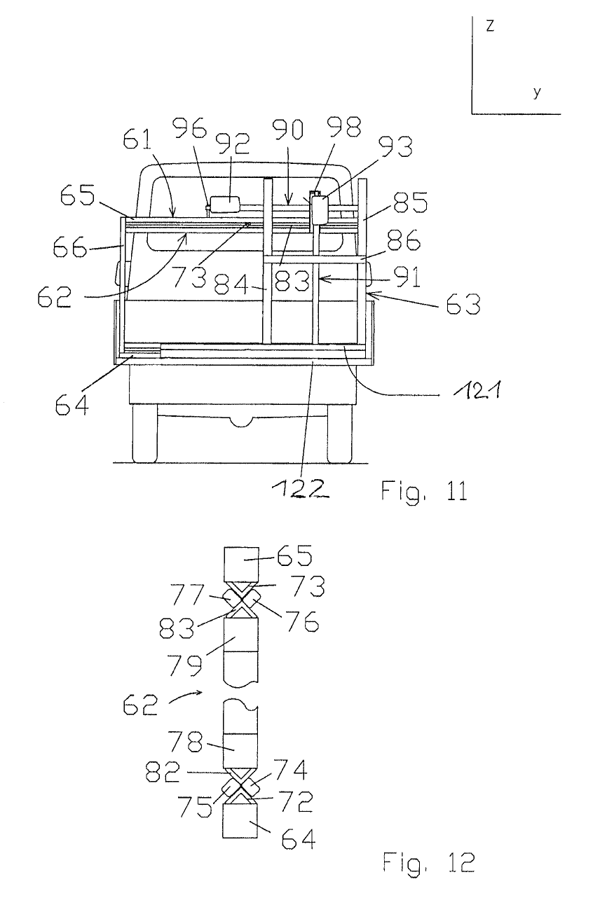

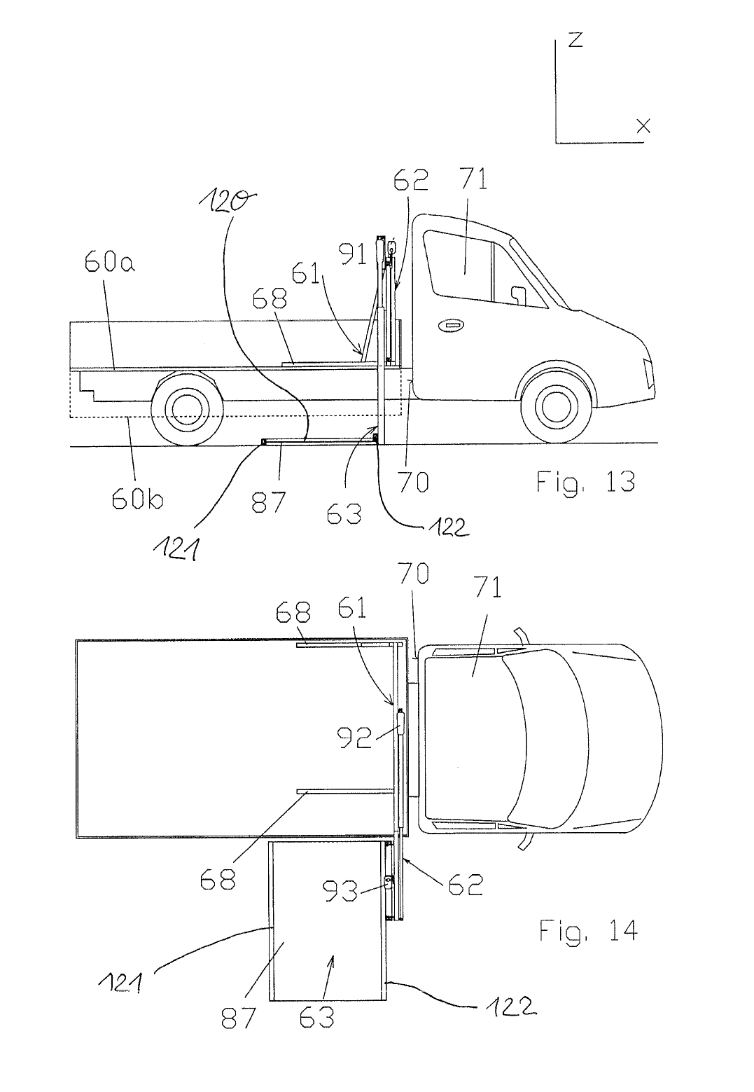

While the embodiment according to FIGS. 1a and b to 8 preferably serves the purpose of moving the loading device inwards or outwards through a boot lid of a vehicle, FIG. 9 to 17 show a loading lift which is used from the side of a vehicle, more specifically on the example of a small lorry with a platform construction which, according to FIGS. 9 and 13, has a loading area 60a and a slide flap 60b which is pivoted downwards and is only indicated in dashed lines in FIGS. 9 and 13. Analogously to the embodiment according to FIGS. 1a and b to 8, the loading lift comprises three modules which are preferably prefabricated and can be assembled together, namely a holding stand 61, a carriage 62 and a loading device 63.

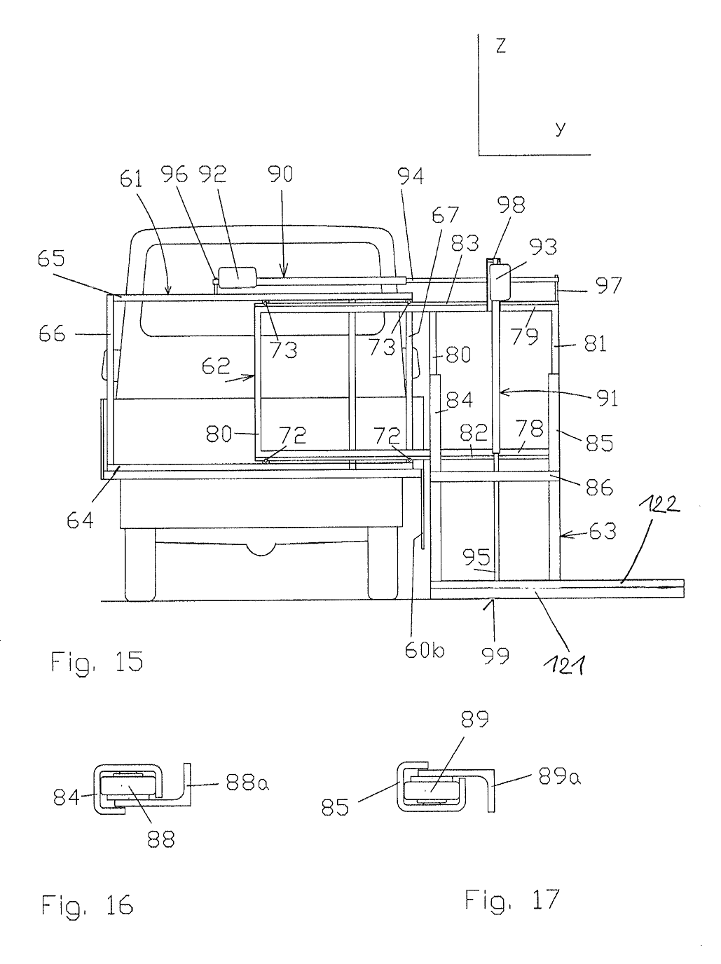

According to FIG. 15, the holding stand 61 has two parallel longitudinal beams 64, 65 and two crossbeams 66, 67 which are arranged vertically thereto and are connected therewith to form a frame. According to FIGS. 9, 10, 13 and 14, this frame is supported on two feet 68 and is additionally held by at least one support 69, the feet 68 and the support 69 in turn forming a substructure used to attach the loading lift to the vehicle. However, unlike FIGS. 1a and b to 8, the frame formed from the beams 64 to 67 is arranged such that it is parallel, for example to the back wall 70 of a driver's cab 71 of the vehicle and its longitudinal beams 64, 65 extend transversely to the direction of travel and parallel to the y-axis of an imaginary coordinate system.

The longitudinal beams 64, 65 and the crossbeams 66, 67 preferably consist of stability-increasing square profiles. Attached to the upper side of the lower longitudinal beam 64 and to the lower side of the upper crossbeam 65 are respectively two 90° angle sections 72 and 73 (FIGS. 12, and 15), on the mutually vertical sides thereof a respective roller 74, 75 and 76, 77 is rotatably attached. The axes of rotation of the rollers 74, 75 and respectively 76, 77 are in each case vertical to one another in pairs corresponding to the position of the two sides of the angle pieces 72, 73, as is clearly shown in FIG. 12.

According to FIG. 15, the carriage 62 preferably has two parallel longitudinal beams 78 and 79 and two crossbeams 80, 81 arranged vertically thereto which are joined together to form a rectangular frame. According to FIG. 12, the longitudinal beams preferably again consist of square profiles and according to FIGS. 12 and 15, respectively two angle pieces, configured as roller rails 82, 83, being continuous over their length and having sides vertical to one another are attached to the lower side of the lower longitudinal beam 78 and to the upper side of the upper longitudinal beam 79. The spacing, measured in the z-direction, of the longitudinal beams 78 and 79 of the carriage 62 is calculated corresponding to the spacing of the longitudinal beams 64, 65 of the holding stand 61 such that the carriage 62 can be moved from at least one side (for example in FIG. 15 from the right-hand side) into the holding stand 61 such that it is positioned between the two longitudinal beams of the holding stand 61 and the ridge lines of the roller rails 82, 83 according to FIG. 12 come to rest between respectively two associated rollers 74, 75 and 76, 77 of the holding stand 61. Due to this arrangement, in the assembled state of the carriage 2, the rollers 74 to 77 run on sides, associated therewith, of the roller rails 82, 83, as a result of which the carriage 62 is mounted displaceably in the holding stand 61 and is guided in said holding stand 61 both vertically (z-direction) and laterally (y-direction).

The loading device 63 is substantially identical to the loading device 3 according to FIGS. 1a and b to 8. It comprises two longitudinal beams or roller rails 84 and 85 which are produced from U- or C-shaped profiles (for example FIGS. 11 and 15) and are connected in a central region by a crossbeam 86 and are provided at their lower ends with a vertically projecting loading element 87 in the form of a loading platform, fork or the like. As given with the embodiment as described with reference to FIG. 1a,b to 8 again a positioning platform 120 to be slid on the loading platform 87 is provided. The preferably rectangular positioning platform 120 comprises guide rails 121, 122 as shown in FIG. 1b and is used in order to enlarge the loading area of the inventive loading lift. When slid on the loading platform 87 the positioning platform 120 is secured against disengaging from the loading platform 46 by means of stoppers provided in one or both guide rails 121, 122. As shown in FIGS. 16 and 17, the roller rails 84, 85 are configured analogously to the roller rails 29, 30 (FIGS. 1a and b to 8) and, in the assembled state, receive respectively two rollers 88 or 89 which are mounted rotatably on angle pieces 88a, 89a. The rollers 88, 89, like the rollers 14 to 17 (FIGS. 1a and b), preferably consist of combination rollers which simultaneously perform a supporting function in the vertical direction and a guiding function in the horizontal direction. The angle pieces 88a, 89a are attached to the crossbeams 80, 81 of the carriage 82 such that the loading device 63 can be positioned from below with its roller rails 84, 85 on the running wheels 88, 89 and then moved along the crossbeams 80, 81. In the embodiment, if the longitudinal axis of the vehicle is arranged parallel to the x-axis of the imaginary coordinate system, the carriage 62 can be moved on the holding stand 61 in the y-direction and the loading device 62 can be moved on the carriage 62 in the z-direction. Furthermore, the holding stand 61, the carriage 62 and the loading device 63 again each form a self-contained module, it being possible for the carriage 62 to be positioned on the holding stand 61 and for the loading device 63 to be positioned on the carriage 62.

The mounting/dismounting and the mode of operation of the loading lift according to FIG. 9 to 17 basically corresponds to that of the loading lift according to FIGS. 1a and b to 8, so that it is unnecessary to describe these functions again.

In principle, it is possible to move the carriage 62 and the loading device 63 manually and, if appropriate, with suitable means in the form of crank handles or the like. However, to carry out these movements, it is preferable to provide a respective drive 90, 91 (for example FIGS. 11 and 15) which is a linear drive analogously to FIGS. 1a and b to 8 and has a respective rod 94, 95 which can be moved by an electric reversing motor 92. The drive 90 is mounted between a hold point 96 on the holding stand 61 and a hold point 97 on the carriage 62, whereas the drive 91 is mounted between a hold point 98 on the carriage 62 and a hold point 99 on the loading device 63. In this respect as well, the loading lift according to FIG. 9 to 17 corresponds to that of FIG. 1a,b to 8, so that a further description is unnecessary.

As shown in particular by FIG. 13 to 15, with the side flap 60b of the vehicle folded down, the loading device 63 is moved out in the y-direction to such an extent that it is positioned completely outside the peripheral contour and the loading area or loading surface 60a of the vehicle. Therefore, the loading device 63 can be lowered in the z-direction until the loading element 87 and the positioning platform 120, respectively rests on the ground or the road and the loading lift occupies a loading position. The positioning platform 120 can be drawn out away from the vehicle depending on distances given. After the loading procedure, the loading device 63 is initially raised to such an extent that the loading element 87 and the positioning platform 120, respectively is at least level with the loading area 60a. The carriage 62 can then be moved with the loading device 63 in the y-direction into the vehicle until the entire loading lift is arranged inside the outer vehicle contour in a transporting position according to FIGS. 10 and 11 and the side flap 60b can be folded up again and locked. Therefore, the only basic difference between the loading lifts according to FIG. 1a,b to 8 and FIG. 9 to 17 is that one can be moved out backwards and the other can be moved sideways out of the vehicle, the boot, the platform or the like.

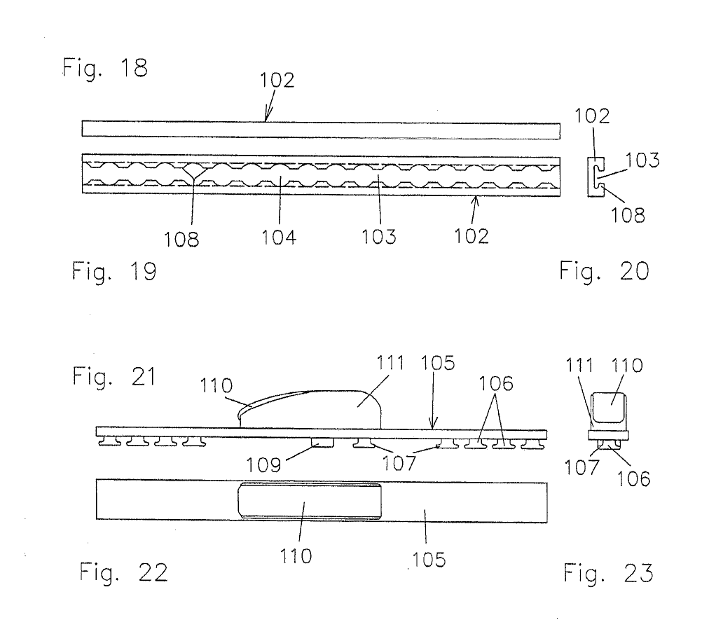

To rapidly assemble and disassemble the holding stand 1 respectively 61 or the substructure thereof 8, 9 (FIGS. 1a,b and 6a,b), quick-acting closures 101 known per se are preferably used which, according to FIG. 18 to 22, have a mounting rail 102 to be attached to the base of the loading area. According to the embodiment of FIG. 18 to 22, the mounting rail 102 consists of a C-shaped profile with, in the assembled state, for example an upwardly open longitudinal slot 103 provided laterally with undercuts (FIG. 20). The lateral edges of this longitudinal slot 103 have circularly expanded openings 104 in a predetermined grid spacing. Furthermore, the quick-acting closure has a sealing element 105 which consists, for example of steel, is to be connected to the holding stand 1, 61 and is provided on its lower side with bolts 106 arranged having the spacing of the openings 104. The free ends of the bolts 106 have circularly expanded heads 107, the diameter of which substantially corresponds to that of the openings 104. Furthermore, the arrangement is such that the heads 107 can be inserted into the openings 104 and then pushed into the longitudinal slot 103. By pushing the sealing element 105 lengthwise relative to the mounting rail 102 by, for example half a grid length, the heads 106 pass into a portion which is located between two openings 104 and has noses 108 which delimit the longitudinal slot 103 and laterally overlap the heads 107 of the bolts 106. Consequently, it is no longer possible to remove, in a vertical direction to this, the sealing element 105 from the mounting rail 102.

The quick-acting closure 101 also has a locking bolt 109 which is used to prevent undesirable displacements of the sealing element 105 in the longitudinal direction of the longitudinal slot 103. The locking bolt 109 is attached to the sealing element 105, being offset by half a grid spacing relative to the bolts 106 and has a diameter which corresponds to the diameter of the openings 104. The locking bolt 109 is also attached to a lever 110 which is pivotally mounted in a holder 111 of the sealing element 105 so that by pressing this lever 110 down, the locking bolt 109 can be guided into one of the openings 104 as soon as the sealing element 105 on the mounting rail 102 occupies a position in which the heads 107 are covered by the noses 108. The sealing element 105 is then fixed immovably and undetachably on the mounting rail 102.

If the holding stand 1, 61 is to be released from the mounting rail 102, first of all the lever 110 is raised until the locking bolt 109 has moved out of the corresponding opening 104. Thereafter, the sealing element 105 together with the holding stand is moved by half a grid length along the mounting rail 102 until the heads 107 are again exactly positioned in respectively one of the openings 104. The holding stand 1, 61 can then be lifted together with the sealing element 105 from the mounting rail 102. Moreover, it is clear, however, that alternatively other quick-acting closures can be used which allow a mounting/dismounting without special tools, although basically a broadly lasting attachment of the holding stand 1, 61 to the loading area would also be possible.

Furthermore, it would be possible to attach the mounting rail 102 to the holding stand and the sealing element 105 to the vehicle or to provide two or more quick-acting closures, the mounting rail 102 of one quick-acting closure being attached to the holding stand and the mounting rail 102 of another quick-acting closure being attached to the vehicle. Apart from this, it is of course also possible to use quick-acting closures which are already present on the vehicle to attach the loading lift according to the invention and for example to provide the holding stand with a means which can cooperate with a quick-acting closure of this type.

Using the described quick-acting closures 101 and due to the modular type of construction, it is possible to reduce the installation time of the loading lift into a motor vehicle for the first installation from, up until now, a few days to a few hours.

The arrangements, described with reference to the two drawings, of the loading lift according to the invention in the motor vehicle are only examples. In particular, it is possible to arrange the embodiment according to FIGS. 1a and b to 8 such that the carriage 2 can be moved in a vertical direction to the longitudinal axis of the vehicle analogously to FIG. 9 to 17, while the embodiment according to FIG. 9 to 17 can also be mounted in a vehicle such that it can be moved in the longitudinal direction of the vehicle. Other than that, both embodiments can also be mounted in a central region of a loading area and/or on a loading area which, laterally or rearwards, is not delimited by a wall. Furthermore, particularly in such a case, it would be possible to configure the holding stand, the carriage and, if appropriate, the drive for the carriage such that the carriage can be moved selectively to one or other side out of the holding stand. Depending on the situation, it would then be possible to use both sides of the vehicle for a loading or unloading procedure.

The invention is not restricted to the described embodiments which can be modified in many ways. This applies in particular to the specific embodiment of the three modules of holding stand, carriage and loading device. Furthermore, means other than those described can be provided to move the carriage on the holding stand and to move the loading device on the carriage. These means can comprise, for example chains, ropes, straps, toothed belts, toothed racks or the like which are present on their own or in addition to the drives and are able to cooperate with a crank handle or the like. The roller guides which have been described are also to be considered as embodiments. In particular, the rollers provided on the holding stand can be provided on the carriage and instead of this, the roller rails of the carriage can be provided on the holding stand. Accordingly, the positions of the rollers of the carriage and the roller rails of the loading device can be interchanged. Combined guides are also possible such that rollers and roller rails are provided both on the holding stand and on the carriage and respectively both on the carriage and on the loading device.

Furthermore, rollers or wheels may be attached to the undersides of the carriers of the holder stands according to the invention and/or to the undersides of the loading platforms. In this way, the loading lift according to the invention can be used as a high-lift truck in buildings or at loading ramps. The inventive loading lift then is mounted to walls or a respective ground area. If the inventive loading lift is used in order to bridge or overcome a level difference in a building or at railroad cars or the like as an aid for elderly or disabled people the loading lift preferably is mounted on an upper level involved. Instead of fixing the loading lift on a ground area or a wall extension arms can be provided at the feet of the holding stand in order to achieve a stable position of the loading lift.

For the positioning platform to be received on the loading platform, a sliding guide may also be provided between the loading platform and the guide rail. In this case, the rollers provided on the front side of the loading platform are superfluous. Instead of the rear guide rail of the receiving platform, which rail faces the roller-rail-type longitudinal carriers once positioned, female coupling carriers may also be provided for fixing the positioning platform on the longitudinal carriers. Similarly, in this case too, it is no longer necessary to provide the pairs of rollers which are provided on the loading platform in the attachment region of the guide rails. Preferably, the positioning platform may be formed as a carriage by means of rollers or wheels on the under side thereof, and advantageously, this carriage can then be loaded in a different place and can easily be slid up to the loading lift according to the invention. Also the positioning platform can be slid on the loading platform and drawn out therefrom by means of drives as described with respect to loading device and the carriage. In this case such drives also can be used in order to avoid unwanted disengaging of the positioning platform from the loading platform.

Furthermore, the materials used to produce the various parts can be selected differently as a function of the individual case, although welded steel constructions are preferred due to the required stability and the relatively low requirement for strength-reducing holes or the like. It can also be advantageous to attach the loading element 46, 87 pivotally to the frame of the loading device or the like, so that after it has been moved into the vehicle, it can be pivoted upwards, thereby providing more free space.

To further reduce the required space, it is also possible to construct the carriage out of two or more components which can be inserted telescopically one inside the other. Furthermore, the drives are preferably remote-controllable and provided with control electronics (not shown). The current is advantageously supplied by a connection cable which can be connected to a socket or the like connected to the battery of the vehicle. This aside, it is obvious that the invention is intended to relate not only to the loading lift itself, but also to a vehicle which is fitted therewith and which can also be a closed van with a door on one side or at the rear or can be a trailer of a vehicle. Furthermore, the holding stand can simultaneously be configured as a holding device for a ladder or a canopy.

Finally, it is understood that the various features can also be used in combinations other than those which have been described and illustrated. It will be understood, that each of the elements described above or two or more together may also find a useful application in other types of construction differing from the types described above.

While the invention has been illustrated and described as embodied in a loading lift for a motor vehicle it is not intended to be limited to the details shown, since various modifications and structural changes may be made without departing in any way from the spirit of the present invention.

Without further analysis, the forgoing so fully reveal the gist of the present invention that others can, by applying current knowledge, readily adapt it for various applications without omitting features that, from the standpoint of prior art, fairly constitute essential characteristics of generic or specific aspects of this invention.

What is claimed as new and desired to be protected by Letters Patent is set forth in the appended claims.

1. Loading lift for a vehicle, in particular for a motor vehicle and/or to overcome a difference of level in a building or at a public transportation ramps and the like comprising a holding stand (1, 61) to be attached to the vehicle and/or a wall or a ground area of the building or to the public transportation ramp, a carriage (2, 62) which can be moved backwards and forwards in a first direction on the holding stand (1, 61) and a loading device (3, 63) which can be mounted on the carriage (2, 62) and can be moved backwards and forwards in a second direction substantially vertical to the first direction between a loading position and a transporting position, wherein the holding stand (1, 61), the carriage (2, 62) and the loading device (3, 63) each consist of a module, it being possible for these modules to be selectively handled individually or to be inserted one inside another and connected together to produce a ready-made constructional unit.

2. Loading lift according to claim 1, wherein the holding stand (1, 61) and/or the carriage (2, 62) is provided with two straight mutually parallel first roller rails (29, 30; 82, 83) and the carriage (2, 62) and/or the holding stand (1, 61) are provided with rollers (14 to 25; 74 to 77) which run on the first roller rails (29, 30; 82, 83).

3. Loading lift according to claim 2, wherein the first roller rails (29, 30; 82, 83) are configured to be C- or U-shaped or angular and the rollers (14 to 25; 74 to 77) are arranged such that they can be moved into or out of the first roller rails (29, 30; 82, 83) from at least one end of said first roller rails (29, 30; 82, 83).

4. Loading lift according to claim 1, wherein the carriage (2, 62) and/or the loading device (3, 63) are provided with two straight, parallel second roller rails (43, 44; 84, 85) and the loading device (3, 63) and/or the carriage (2, 62) are provided with further rollers (34, 35, 38, 39; 88, 89) which run on the second roller rails (43, 44; 84, 85).

5. Loading lift according to claim 4, wherein the second roller rails (43, 44; 84, 85) are configured to be C- or U-shaped and the further rollers (34, 35, 38, 39; 88, 89) are arranged such that they can be moved into or out of the second roller rails (43, 44; 84, 85) from at least one end of said second roller rails (43, 44; 84, 85).

6. Loading lift according to claim 1, wherein a first drive (48, 90) is provided for moving the carriage (2, 62) relative to the holding stand (1, 61).

7. Loading lift according to claim 6, wherein the first drive (48, 90) comprises a first linear drive which is arranged between a hold point (50, 96) on the holding stand (1, 61) and a hold point (51, 97) on the carriage (2, 62) and can be detachably connected to the hold points (51, 96; 52, 97).

8. Loading lift according to claim 1, wherein a second drive (49, 91) is provided for moving the loading device (3, 63) relative to the carriage (2, 62).

9. Loading lift according to claim 8, wherein the second drive (49, 91) comprises a second linear drive which is arranged between a hold point (52, 98) on the carriage (2, 62) and a hold point (53, 99) on the loading device (3, 63) and can be detachably connected to these hold points (52, 98; 53, 99).

10. Loading lift according to claim 7, wherein the first and/or second linear drive is operated electrically.

11. Loading lift according to claim 1, wherein the loading device (3, 63) has a frame (63 to 65; 84 to 86) which can be mounted displaceably on the carriage (2, 62) and a loading element (46, 87) which projects perpendicularly thereto from the frame.

12. Loading lift according to claim 11, wherein the loading element (46, 87) is a platform or a fork.

13. Loading lift according to claim 11 or 12, wherein a positioning platform (120) is slidably engaged to the loading platform (46, 87).

14. Loading lift according to claim 11, wherein the loading element (46, 87) is arranged such that it can be folded up on the frame (43 to 45; 84 to 86).

15. Loading lift according to claim 1, wherein the holding stand (1, 61) is provided at one end with a substructure (8, 9; 68; 69) which is intended to be attached to a side wall, front wall, ground area or a back wall of the loading area of the vehicle and/or to a wall or a ground area of the building or to the public transportation ramp and the like.

16. Loading lift according to claim 15, wherein the substructure (8, 9; 68; 69) is provided with at least one quick-acting closure (101) intended to be attached to the vehicle and/or to the building or to the public transportation ramp or is provided with a means which can cooperate with a quick-acting closure present on the vehicle and/or the building or to the public transportation ramp and the like.

17. Loading lift according to claim 1, wherein chains, ropes, straps, toothed belts or toothed racks are provided to move the carriage (2, 62) and/or the loading device (3, 63) backwards and forwards.

18. Loading lift according to claim 17, wherein the chains, ropes, straps, toothed belts or toothed racks are provided exclusively or additionally to the drives (48, 49; 90, 91).

19. Loading lift according to claim 17, wherein a crank handle is associated with the chains, ropes, straps, toothed belts or toothed racks.

20. Loading lift according to claim 1, wherein the carriage (2, 62) comprises at least two components which are inserted telescopically one inside the other in the first direction.

21. Loading lift according to claim 6, wherein the drives (48, 49; 90, 91) are remote-controllable.

22. Loading lift according to claim 6, wherein associated with the drives (48, 49; 90, 91) are limit switches which determine the movement strokes of the carriage (2, 62) and/or of the loading device (3, 63).

23. Loading lift according to claim 21, wherein control electronics are associated with the drives (48, 49; 90, 91).

24. Motor vehicle having a loading area (60a), wherein a loading lift according to at least one of claims 1 to 20 is mounted on the loading area (60a).

25. Motor vehicle according to claim 24, wherein the holding stand (1, 61) is attached to the loading area (60a).

26. Motor vehicle according to claim 24, wherein the loading area (60a) is delimited by a side wall or a back wall and the holding stand (1, 61) is arranged close to the wall.

27. Motor vehicle according to claim 24, wherein to supply the drives (48, 49; 90, 91) with current, a connection cable is provided which fits into a socket connected to a vehicle battery.
